(19) United States
(12) Patent Application Publication
(10) Pub. No.: US 2007/0246288 A1
(43) Pub. Date: Oct. 25, 2007

(54) Dual force hydraulic steering system for articulated work machine

(76) Inventors: Daniel T. Mather, Lockport, IL (US); David A. Mork, Yorkville, IL (US); Rabie E. Khalil, Dunlap, IL (US)

Correspondence Address: CATERPILLAR c/o LIELL & MCNEIL ATTORNEYS PC, P.O. BOX 2417, 511 SOUTH MADISON STREET, BLOOMINGTON, IN, 47402-2417, US

(21) Appl. No.: 11/410,167

(22) Filed: Apr. 24, 2006

(51) Int. Cl. B62D 5/06

(52) U.S. Cl. 180/418

(57) ABSTRACT

An articulated work machine is steered via left and right hydraulic cylinders that swivel a front portion of a work machine relative to a back portion about a vertical articulation axis. When a low force turn is being performed, high pressure is supplied to only one of the left and right hydraulic cylinders. When a high force turn is performed, high pressure is supplied to one of the left and right hydraulic cylinders, and pressurized hydraulic fluid is also supplied to the other of the left and right hydraulic cylinders in proportion to the torque required for the turn. This strategy allows for excess pressurized fluid, which is not used for the steering purpose, to be utilized by hydraulic implements of the work machine to increase performance capabilities while the machine is being steered in low force mode under light steering load.

### TECHNICAL FIELD

The present disclosure relates generally to hydraulic steering systems for articulated work machines, and more particularly to a hydraulic steering system with a low force mode and a high force mode.

### BACKGROUND

Articulated work machines typically include a front portion joined to a back portion via an articulation joint that defines a vertical steering axis. Steering is accomplished by swiveling the front portion relative to the back portion about the articulation axis using a left hydraulic cylinder and a right hydraulic cylinder. In conventional steering systems of this type, a main steering valve supplies the head end of one hydraulic cylinder and the rod end of the other hydraulic cylinder with high pressure to facilitate swiveling the front portion relative to the back portion around about the articulation axis. The fluid displaced by the pistons of the left and right hydraulic cylinders is returned to tank via low pressure drain lines. While this type of steering hydraulic system has performed well for many years, there remains room for improvement.

One purported improvement to the classic articulated hydraulic steering system is described in U.S. Pat. No. 5,193,637. In that hydraulic steering system, high pressure is only supplied to one or the other of the left and right hydraulic cylinders to facilitate a turn when the torque demand to complete the turn is relatively low. Thus, below some threshold, the hydraulic pump can make extra pressurized fluid available to operate hydraulic implement systems while the vehicle is operated in a low force steering mode. When steering torque demands exceed a threshold, the steering system behaves similar to that of the classic hydraulic steering system described above. Thus, when a vehicle of the '637 patent is in a high force steering mode, excess fluid pressure is not available for operating hydraulic implement systems. The '637 vehicle also includes several subtle but important drawbacks. For instance, substantial pressure waves and associated vibrations are generated when transitioning between its low force and high force steering modes. Thus, a work machine using the '637 hydraulic steering system produces annoying and potentially destructive pressure waves in the transition region rendering its steering system less than transparent to a machine operator.

The present disclosure is directed to one or more of the problems set forth above.

### SUMMARY OF THE DISCLOSURE

In one aspect, a hydraulic steering system includes a left hydraulic cylinder with a left first volume separated from a left second volume by a left piston, and a right hydraulic cylinder with a right first volume separated from a right second volume by a right piston. A main steering valve is fluidly connected to the left first volume and the right first volume. A left high force steering valve is fluidly connected to the left second volume. A right high force steering valve is fluidly connected to the right second volume.

In another aspect, a method of steering an articulated work machine includes a step of performing a left hand high force turn by fluidly connecting a first right volume of a right hydraulic cylinder to high pressure, fluidly connecting a second right volume and a left first volume of a left hydraulic cylinder to low pressure, and supplying a left second volume with a medium pressure between the high and low pressures. A right hand high force turn is accomplished by fluidly connecting the left first volume to high pressure, fluidly connecting the left second volume and the right first volume to low pressure, and supplying the right second volume with a medium pressure between the high and low pressures.

In still another aspect, a cartridge valve includes a valve body with a high pressure port, a low pressure port, a first cylinder port and a second cylinder port. A valve member is at least partially positioned in the valve body and is movable among a continuum of positions corresponding to different flow areas from the high pressure port to the second cylinder port.

### BRIEF DESCRIPTION OF THE DRAWINGS

FIG. 1 is a side elevational view of an articulated work machine according to the present disclosure;

FIG. 2 is a partial schematic of a hydraulic steering system according to the present disclosure;

FIG. 3 is a hydromechanical steering schematic according to one aspect of the present disclosure;

FIG. 4 is an electrohydraulic steering schematic according to another aspect of the present disclosure;

FIG. 5 is a graph of control port pressure to pilot signal pressure for current and past hydraulic steering systems; and

FIG. 6 is a graph of steering torque verses steering speed comparing the present disclosure to the classic articulated hydraulic steering systems.

### DETAILED DESCRIPTION

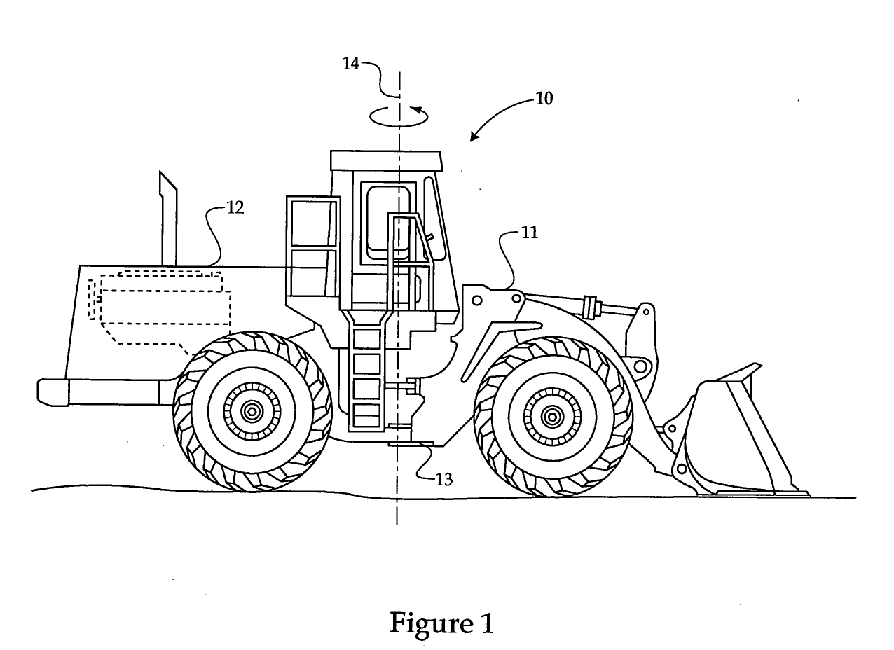

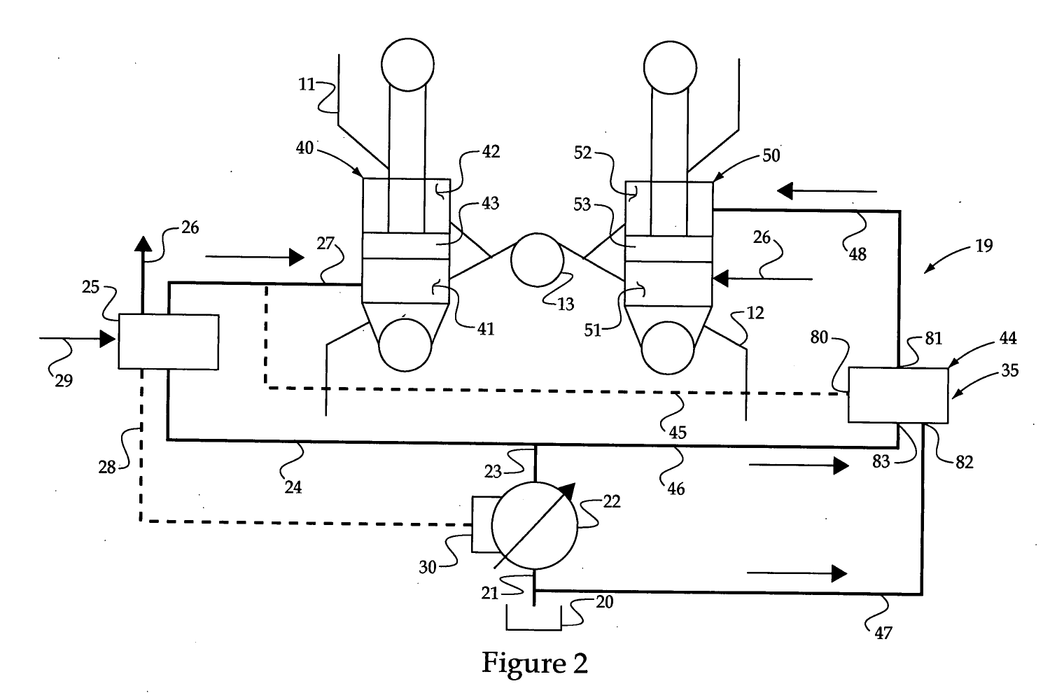

Referring to FIGS. 1 and 2, an articulated work machine 10 includes a front portion 11 joined to a back portion 12 at an articulation joint 13. Articulation joint 13 that permits work machine 10 to steer by swiveling front portion 11 with respect to back portion 12 about a vertical articulation steering axis 14. Work machine 10 includes a hydraulic steering system 19 that includes a left hydraulic cylinder 40 with one end connected to front portion 11 and an opposite end connected to back portion 12. Hydraulic steering system 19 also includes a right hydraulic cylinder 50 with one end attached to front portion 11 and an opposite end connected to back portion 12. As stated earlier, work machine 10 can be steered by actuating one or both of hydraulic cylinders 40 and 50 to swivel the front portion 11 about articulation joint 13 with respect to back portion 12. Left hydraulic cylinder 40 includes a left first volume 41 separated from a left second volume 42 by a piston 43. Likewise, right hydraulic cylinder 50 includes a right first volume 51 separated from a right second volume 52 by a right piston 53.

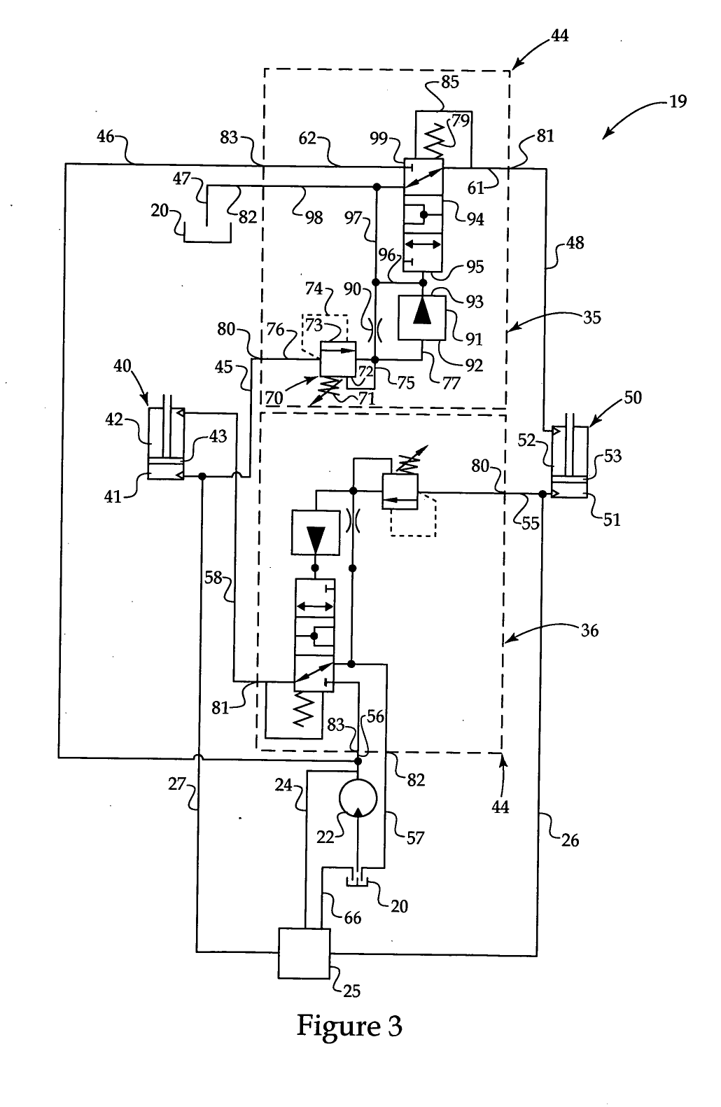

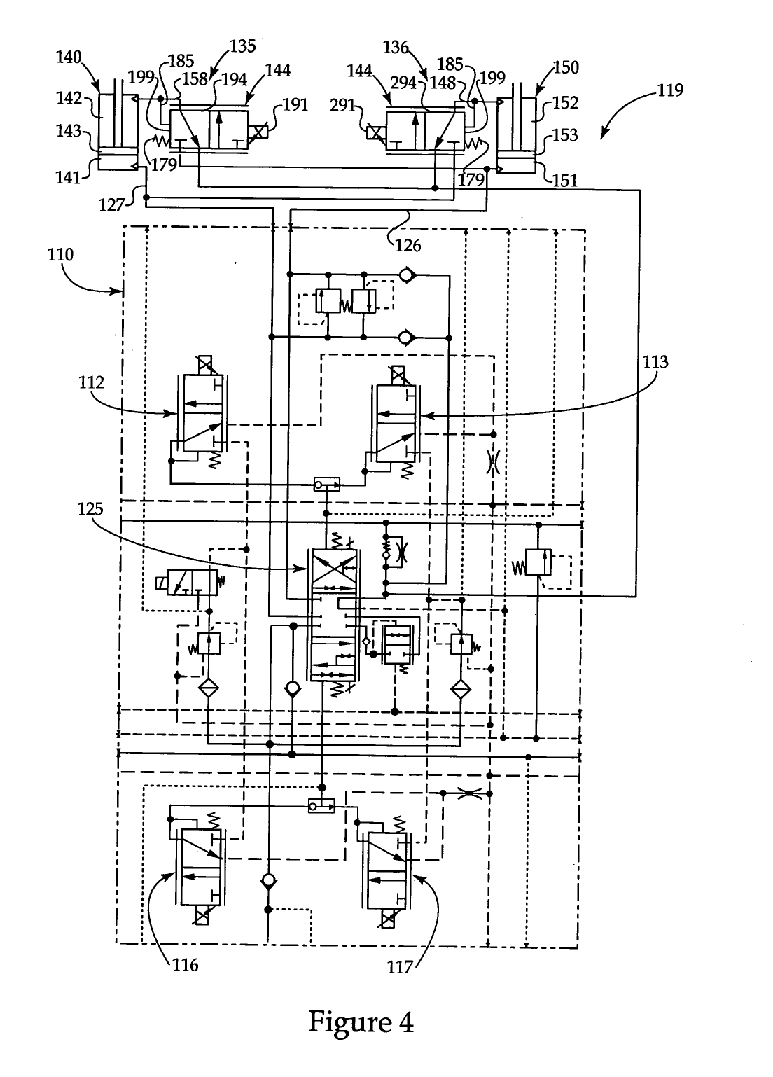

Hydraulic steering system 19 includes a drain 20 that is fluidly connected to a high pressure pump 22 via a low pressure supply line 21. Output from high pressure pump 22 is supplied to a main steering valve 25 via a high pressure output line 23 and a main steering valve supply line 24. Main steering valve 25 receives a right turn steering command signal 29 in a conventional manner to channel high pressure fluid in main steering valve supply line 24 to either a left cylinder supply line 27 or a right cylinder supply line 26, which is shown unconnected to the right hydraulic cylinder in this illustration. In other words, FIG. 2 does not show all of the fluid connections necessary for performing a left hand turn, instead it shows the fluid connections for completing a right hand turn, but the same oppositely connected hydraulic circuit exists as illustrated in the schematics of FIGS. 3 and 4 and discussed infra. The main steering valve 25 is in communication with pump controller 30 via a load signal line 28 to make the pump pressure responsive to the steering command signal 29. The main steering valve 25 is fluidly connected to right first volume 51 via right cylinder supply line 26, and fluidly connected to the left first volume 41 via left cylinder supply line 27.

Hydraulic steering system 19 also includes a right high force steering valve 35 that is fluidly connected to the right second volume 52 via fluid line 48. Right high force steering valve 35 may take the form of a cartridge 44 that includes a first cylinder port 80 fluidly connected to left first volume 41 via pilot pressure line 45 and a segment of left cylinder supply line 27. In addition, cartridge 44, and hence right high force steering valve 35 includes a second cylinder port 81 fluidly connected to right second volume 52 via fluid line 48. Right high force steering valve 35 also includes a high pressure port 83 fluidly connected to high pressure pump 22 via high force supply line 46 and high pressure output line 23. Finally, right high force steering valve 35 includes a low pressure port 82 fluidly connected to drain 20 via low force supply line 47 and low pressure supply line 21.

Referring now to FIG. 3, a hydro mechanical version of hydraulic steering system 19 is illustrated to include both the right high force steering valve 35 shown in FIG. 2 and also a left high force steering valve 36 that was omitted from FIG. 2 for clarity. As stated earlier, both of the left and right high force steering valves 35 and 36 may be substantially identical, and each include a first cylinder port 80, second cylinder port 81, a low pressure port 82 and a high pressure port 83 that open from a cartridge 44 to facilitate installation, servicing and replacement of the respective valves. Nevertheless, those skilled in the art will appreciate that both left and right high force steering valves 35 and 36 could have their individual components separated from one another rather than being housed together in a cartridge 44 as shown. Only the internal features of right high force steering valve 35 will be described since the internal components of left high force steering valve 36 are identical.

Right high force steering valve 35 includes a dual force relief valve 70 that is normally biased to a closed position, as shown, via a biasing spring 71. However, a pressure surface 73 is acted upon by fluid pressure in pressure line 74, which is connected to pilot supply line 76. Thus, fluid pressure acting on pressure surface 73 corresponds to the fluid pressure in left first volume 41 of left hydraulic cylinder 40. Dual force relief valve 70 also includes a second pressure surface 72 that is acted upon by fluid pressure in pressure line 75. When dual force relief valve 70 is in its closed position as shown, pressure line 75 is at drain pressure via the fluid connections through orifice 90, low pressure passage 97, low pressure passage 98, low force supply line 47 and drain 20. A pressure differential on pressure surfaces 73 and 72 sufficiently large to overcome biasing spring 71 move valve 70 to its open position to fluidly connect pilot supply line 76 to piston pressure line 77. When dual force relief valve 70 is in its closed position, as shown, the hydraulic steering system 19 is operating in a low force steering mode. The transition to the high force steering mode occurs when dual force relief valve 70 opens, at a selected pressure differential that defines the transition from the low force mode to the high force mode. Those skilled in the art will appreciate that this pressure can be selected by choosing appropriate effective pressure surface area 72 and 73 along with a selected preload on biasing spring 71, in a manner well known in the art.

Right high force steering valve 35 also includes a pilot piston 91 with a pressure surface 92 exposed to fluid pressure in piston pressure line 77. Pilot piston 91 also includes a contact surface 93 that allows the pilot piston 91 to push right valve member 94 against the action of regulating spring 79 and any fluid pressure force due to fluid pressure in pressure line 85 acting on pressure feedback surface 99. Fluid pressure on contact surfaces 93 and 95 is minimized via a connection of vents 96 to drain 20 via low pressure passages 97 and 98. When pressure is low, right valve member 94 is biased to a first position, as shown, where the right second volume 52 of right hydraulic cylinder 50 is fluidly connected to drain 20 via fluid lines 48, 61, low pressure passage 98 and low force supply line 47. Right valve member 94 also includes a second position where right second volume 52 is fluidly disconnected from drain 20 but fluidly connected to high pressure pump 22 via high pressure line 62 and high force supply line 46. Between the first and second positions, a continuum of positions exist where right second volume 52 is fluidly connected to both drain 20 and to high pressure pump 22 via low pressure line 98 and high pressure passage 62, respectively. Each of these continuum of positions corresponds to a different flow area between high pressure passage 62 to right second volume 52. But because right second volume 52 is also fluidly connected to drain 20, the fluid pressure acting on piston 53 and right second volume 52 is a medium pressure between the low pressure of drain 20 and the high pressure from high pressure pump 22 acting on left first volume 41. In addition, each of the continuum of positions corresponds to a different ratio of fluid pressure in the left first volume 41 to right second volume 52. This is accomplished since the pressure acting on pilot piston 91 is a function of the fluid pressure in left first volume 41, but this hydraulic force is opposed in part by fluid pressure acting on pressure surface 99 of right valve member 94 via pressure line 85, which is fluidly connected to right second volume 52.

Left high force valve 36 may be a cartridge 44 that includes identical internal components and features to that of cartridge 44 associated with right high force valve 35. However, the fluid ports of the left high force valve 36 are fluidly connected opposite to that of the right high force valve 35. In particular, first port 80 is fluidly connected to right first volume 51, second cylinder port 81 is fluidly connected to left second volume 42 via fluid line 58, low pressure port 82 is fluidly connected to drain 20 via low force supply line 57, and high pressure port 83 is fluidly connected to high pressure pump 22 via high force supply line 56.

Referring now to FIG. 4, an electro hydraulic steering system 119 according to the present disclosure is illustrated as an alternative to the hydro mechanical version illustrated in association with FIG. 3. Electro hydraulic steering system 119 is illustrated as including a conventional valve block 110 that includes an internal structure associated with a conventional articulated steering system that has been modified to include a right high force steering valve 135 and a left high force steering valve 136. The primary components housed in block 110 include a left proportional pilot solenoid valve 112 that is utilized to apply a hydraulic force to one end of main steering valve spool 125 in a conventional manner. In addition, a left redundant proportional pilot solenoid valve 113 is available in case of failure of primary valve 112. Block 110 also includes a right proportional pilot solenoid valve 116 for applying a hydraulic force to the opposite end of main steering valve spool 125. A right redundant proportional pilot solenoid valve 117 is available in case of failure in valve 116. Depending upon which way main steering valve spool 125 is pushed, either right cylinder supply line 126 or left cylinder supply line 127 will be fluidly connected to a high pressure pump line, and the other connected to drain to facilitate a turn in a conventional manner. Thus, main steering valve 125 can be thought of as being fluidly connected to the left first volume 141 of left hydraulic cylinder 140, and right first volume 151 of right hydraulic cylinder 150 via supply lines 127 and 126, respectively. As in the previous version, left hydraulic cylinder 140 includes a left first volume 141 separated from a left second volume 142 by a piston 143. Likewise, right hydraulic cylinder 150 includes a right first volume 151 separated from a right second volume 152 by a right piston 153. The right high force valve 135 is fluidly connected to the right second volume 152 via fluid line 148, whereas the left high force valve 136 is fluidly connected to the left second volume 142 via fluid line 158.

Both left and right high force valves 135 and 136 may be of an identical structure to include a valve member 194 that is biased via a biasing spring 179 to a position where the respective right second volume 152 or left second volume 142 are fluidly connected to drain. The valve member 194 may also be influenced by fluid pressure in the respective right or left second volume 152 or 142 via pressure line 185 acting on opposition surface 199. The valve member may be moved to a second extreme position by a respective electrical actuator 191 or 291 to a position where the respective right second volume 152 or left second volume 142 are fluidly disconnected from the drain but fluidly connected directly to high pressure via main steering valve spool 125. Between these extreme positions are a continuum of positions that correspond to different flow areas from high pressure to the respective right and left second volumes 152 and 142. Thus, in each of the continuum of intermediate positions, the respective right and left second volumes 152 and 142 are fluidly connected both to drain and to high pressure, assuming that main steering valve 125 is in a position to supply high pressure for a turn. Thus, electrical actuator 291 or 191 provide a balance in opposition to the spring force from biasing spring 179 and any hydraulic force acting on opposition surface 199 from fluid pressure in the respective right second volume or left second volume 152 and 142, respectively.

### INDUSTRIAL APPLICABILITY

Referring to FIGS. 1-4, when work machine 10 is operating and undergoes a relatively low torque turn, only one of the left and right hydraulic cylinders 40, 140 and 50, 150 is supplied with high pressure. For instance, in the case of the hydromechanical embodiment of FIG. 3, and assuming a right hand low force turn, main steering valve will fluidly connect left first volume 41 to high pressure via left cylinder supply line 27, but the right first volume 51 will be connected to drain 20 via right cylinder supply line 26 and drain passage 66. Because the fluid pressure required for the turn is relatively low, dual force relief valve 70 remains closed such that pilot piston 91 is isolated from the fluid pressure in left first volume 41. In other words, the hydraulic actuator of the right high force valve 35 is disconnected from the relatively higher pressure existing in first left volume 41. The left second volume 42 will be fluidly connected to drain via fluid line 58 and low force supply line 57. Likewise, right second volume 52 will be fluidly connected to drain via fluid line 48 and low force supply line 47 via valve member 94. Thus, the higher pressure in left first volume 41 pushes against piston 43, which causes the front portion 11 of work machine 10 to swivel to the right with respect to back portion 12. The right hand hydraulic cylinder 50 will not assist in the turn since both of its volumes are fluidly connected to drain. A low force left hand turn is performed in much the same manner except that the right first volume 51 is fluidly connected to pump 22 by main steering valve 25, and left first volume 41 will be fluidly connected to drain 20 via drain passage 66. The left and right second volumes 42 and 52 remain connected to low pressure at all times when the system is in a low force mode. Because only a portion of pump 22 is capability is being used to facilitate a low force turn, the pump has the capacity to produce excess pressurized fluid that may be utilized by work machine implements or other aspects of the hydraulic system when the work machine 10 is undergoing a low force turn. In electro hydraulic version 119, electrical actuators 191 and 291 remain de-energized.

As the torque required to facilitate a turn increases, the fluid pressure necessary to facilitate the turn also increases. At some predetermined pressure corresponding to a predetermined steering torque, the dual force relief valve 70 will be pushed to an open position. Thus, when transitioning to a high force right hand turn, pressure in left first volume 41 will eventually reach a point that causes dual force relief valve 70 to push open and pressurize piston pressure line 77 to push pilot piston 91 and valve member 94 against the action of regulating spring 79. When this occurs, a high pressure fluid connection to right second volume 52 is partially opened at one of the intermediate continuum of positions provided by valve member 94. This results in a medium pressure, between that of the high pressure output of pump 22 and that of drain 20, so that additional torque to facilitate the turn is accomplished by the right hydraulic cylinder 50. However, the regulating aspect of spring 79 along with pressure line 85 acting on regulating surface 99 cause valve member 94 to move toward an equilibrium position that is associated with the pressure ratio of second right volume 52 to left first volume 41 as dependent on the area ratio of pressure surface 92 to pressure feedback surface 99. At extreme high pressure right turns, the higher pressure acting on pilot piston 91 may push valve member 94 to its extreme second position, at least briefly, to fluidly close right second volume 52 to low pressure and exclusively connect the same to high pressure via lines 46 and 48. The self regulating aspect of the present disclosure results in the right hydraulic cylinder 50 only being used sufficiently to respond to the steering torque demands, but this still results in excess fluid being available from high pressure pump 22 to power hydraulic work implements during a low force turn. A left hand high force turn operates in a much similar, but opposite manner to that of a right hand turn. In other words, the valving associated with left hand high force valve 36 gradually increases the pressure in left second volume 42 when steering torque demands raise fluid pressure in right first volume 51 above a threshold to open the dual force relief valve associated with the right high force valve 36. In electro hydraulic steering system accomplishes a high force turn by energizing one of the left and right electrical actuators 191, 291 proportional to the pressure ratio of the left (or right) first volume to the right (or left) second volume.

Referring now to FIG. 4, the electrohydraulic steering system 19 performs substantially identical to that of the hydromechanical version of FIG. 3, but does so utilizing sensed pressures and electrical actuators to appropriately position the various valves. In particular, when performing a low force right hand turn, both left and right electrical actuators 191 and 291 are deenergized so that the left and right second volumes 142 and 152 are fluidly connected to drain. When the steering torque demand increases above some threshold, which may be detected in any known suitable manner such as via pressure sensors associated with the hydraulic cylinders 140 and 150, the electrical actuator 291 will be energized to move valve member 194 of right high force steering valve 135 to a proportional position that opens second right volume 152 simultaneously to high and low pressure to provide a medium pressure mix to act upon piston 153 to assist in the turn. Those skilled in the art will appreciate that as torque demand increases, the current supplied to electrical actuator 291 also increases to provide a proportional increase in the added torque provided by right hydraulic cylinder 150 to facilitate a right hand turn. When maximum steering torque in a right hand turn is required, an increased current is supplied to electrical actuator 291 to move it completely to its second position that fluidly disconnects second right volume 152 to low pressure and connects the same exclusively to high pressure so that both the left and right hydraulic cylinders 140 and 150 contribute about equally to facilitating a maximum torque turn. A left hand high force turn is performed in a similar manner except that left electrical actuator 191 is energized proportional to the fluid pressure in right first volume 151 to supply an appropriate medium pressure to left second volume 142 via left high force valve 136.

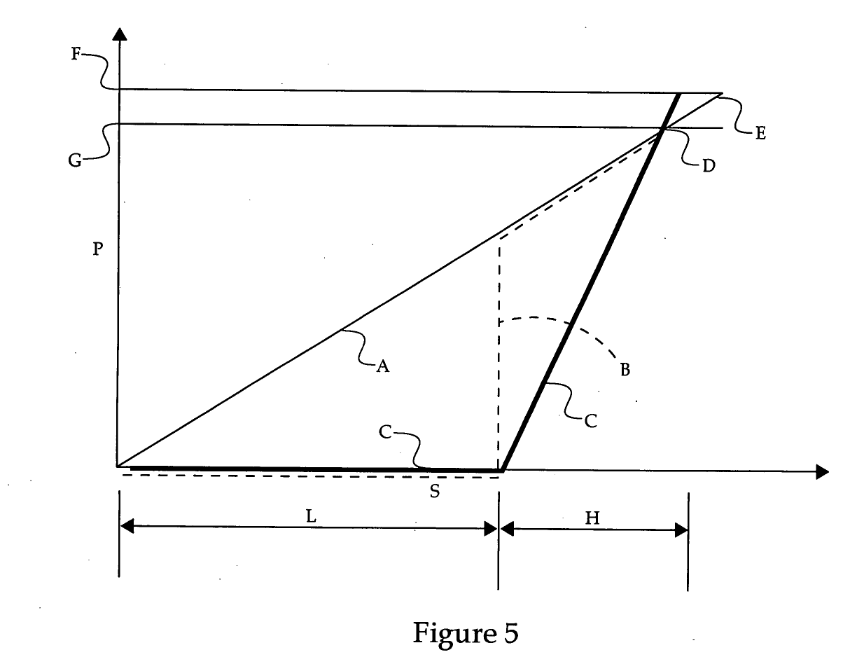

Referring now to FIG. 5, the pressure modulation characteristic for the high force steering valve in the present disclosure are shown in curve C in a graph of control port pressure P verses pilot signal pressure S. Control port pressure P corresponds to the pressure in piston pressure line 77 acting on pilot piston 91 for a right hand turn. Thus, the pilot signal pressure corresponds to the pressure in the left first volume 41 for a right hand turn. Thus, throughout the low force range L, the dual force relief valve 70 remains closed so that pressure acting on pilot piston 91 remains at drain pressure levels. As pressure demands increase, the disclosure transitions from low force range L to high force range H, and this is accomplished by dual force relief valve 70 opening. At this same time, and as pressure further increases for a higher steering torque demand, pressure in left first volume 41 continues to increase, and hence the pressure acting on pilot piston 91 also increases. This increase in pressure acting on pilot piston 91 results in the piston pushing valve member 94 to a position that connects the right second volume 52 to high and low pressure to provide a medium pressure force on right piston 53 to assist in the turn. If the pressure forces continue to increase, curve C eventually arrives at point D, which corresponds to the max power operating point. This point corresponds to when valve member 94 is moved to its complete second position to fluidly disconnect right second volume 52 from low pressure and connect the same exclusively to high pressure. The graph shows that max power operating point D is associated with the max power pressure limit G. The curve also shows that the pump pressure limit F is associated with a point E, which corresponds to a maximum steering torque available at a stall operating point.

The curve C may be compared to curve A that corresponds to a conventional hydraulic steering system where both hydraulic cylinders are utilized across the operating range to facilitate a turn. In general, the region between curve A and curve C reflects an indication of the excess pump output available in the present disclosure to power hydraulic work implements of the work machine during a turn. Curve C may also be compared to curve B which illustrates the behavior of the steering system described in U.S. Pat. No. 5,193,637 discussed earlier. The vertical segment of curve B illustrates the relatively abrupt transition from the low force range to the high force range of the steering system described in that patent. Because the higher force of the present disclosure comes on only gradually after transitioning to the higher force range, several improvements are realized. First, the transition to the high force range is much smoother and will be more transparent to the operator, and will occur without the type of pressure waves and vibrations associated with the nearly vertical transition illustrated by curve B of the '637 patent.

Those skilled in the art will appreciate that the size of low force range L, and where the transition occurs, are matters of design choice that can be implemented by appropriate spring and hydraulic surface sizing in the case of the FIG. 3 embodiment, and with appropriate software and signal strength adjustments to electrical actuators associated with the FIG. 4 embodiment.

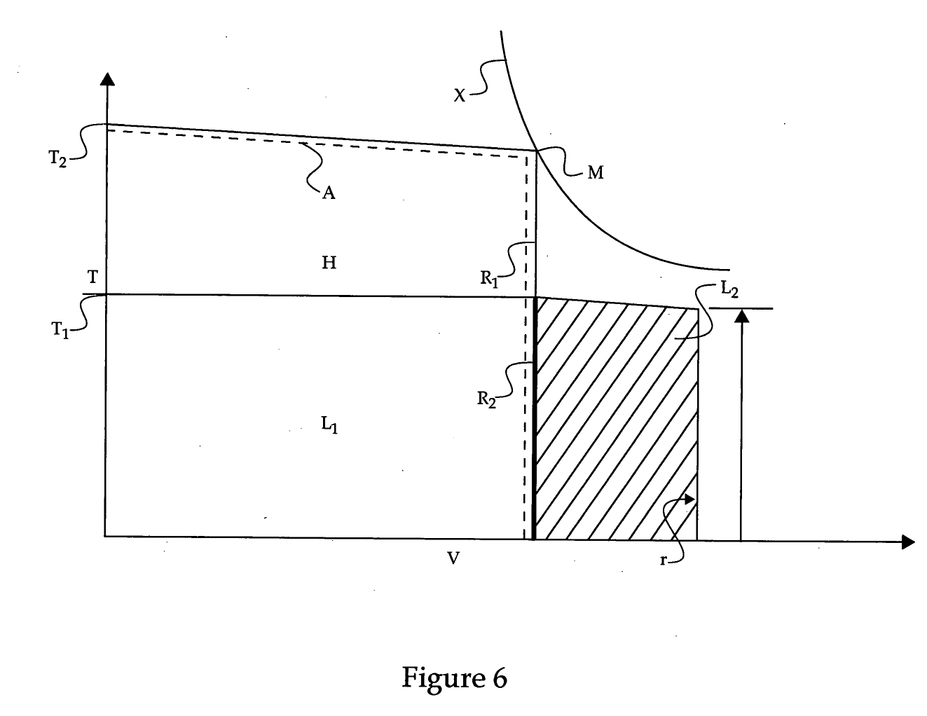

Referring now to FIG. 6, a graph of steering torque T to steering speed V illustrates the advantages of the present disclosure over that of a conventional steering system curve shown identified with the dotted line curve of A. In a conventional system, steering speed reaches a maximum at M, corresponding to the max power operating point governed in part by hardware constraints X. Max power operating point M is arrived at in a known manner, but is lower than stall torque T₂. Whenever steering torque is below a low force torque limit T₁, an extended low force region L₂ is available to the present disclosure, whereas the conventional steering system is restricted to low force region L₁. Extended low force region L₂ is bounded on one side by a low force speed sensitive limit r, such that steering speed in region L₂ allows for higher steering speeds that are influenced by engine speed. Thus, curve r demonstrates that maximum steering speed when pump flow is limited in a low force mode drops with engine speed. However, maximum steering speed when valve flow is limited in the low force mode corresponding to curve R₂ does not drop with engine speed. When steering torques are above that of low force torque limit T₁, both the conventional steering system reflected by curve A and that of the present disclosure are constrained on one side by hardware constraints X, but drop with engine speed. Those skilled in the art will appreciate that the references to engine speed reflect a conventional system where the hydraulic pump is driven directly by the engine.

It should be understood that the above description is intended for illustrative purposes only, and is not intended to limit the scope of the present invention in any way. Thus, those skilled in the art will appreciate that other aspects, objects and advantages of this invention can be obtained from a study of the drawings, the disclosure and the appended claims.

1. A hydraulic steering system comprising:
a left hydraulic cylinder with a left first volume separated from a left second volume by a left piston;
a right hydraulic cylinder with a right first volume separated from a right second volume by a right piston;
a main steering valve fluidly connected to the left first volume and the right first volume;
a left high force steering valve fluidly connected to the left second volume; and
a right high force steering valve fluidly connected to the right second volume.

2. The hydraulic steering system of claim 1 wherein each of the left and right high force valves has a continuum of positions; and
each of the continuum of positions corresponding to different flow areas from a high pressure source to the respective left and right second volumes.

3. The hydraulic steering system of claim 2 wherein each of the positions of the left high force steering valve corresponds to a different pressure ratio of the left first volume to the right second volume; and
each of the positions of the right high force steering valve corresponds to a different pressure ratio of the right first volume to the left second volume.

4. The hydraulic steering system of claim 3 wherein the left high force steering valve is housed in a first cartridge; and
the right high force steering valve is housed in a second cartridge.

5. The hydraulic steering system of claim 3 wherein the left high force steering valve includes a hydraulically movable left valve member; and
the right high force steering valve includes a hydraulically movable right valve member.

6. The hydraulic steering system of claim 5 including a left pilot piston operably coupled to the left valve member; and
a right pilot piston operably coupled to the right valve member.

7. The hydraulic steering system of claim 6 wherein the left high force steering valve includes a left dual force relief valve fluidly positioned between the left first volume and a pressure surface of the left pilot piston; and
the right high force steering valve includes a right dual force relief valve fluidly positioned between the right first volume and a pressure surface of the right pilot piston.

8. The hydraulic steering system of claim 5 wherein the left high force steering valve includes a left regulating spring positioned to bias the left valve member toward a position at which the right second volume is fluidly connected to a low pressure source but fluidly closed to a high pressure source; and
the right high force steering valve includes a right regulating spring positioned to bias the right valve member toward a position at which the left second volume is fluidly connected to the low pressure source but fluidly closed to the high pressure source.

9. The hydraulic steering system of claim 3 wherein the left high force steering valve includes a left electrical actuator operably coupled to a left valve member; and
the right high force steering valve includes a right electrical actuator operably coupled to a right valve member.

10. A method of steering an articulated work machine, comprising the steps of:
performing a left hand high force turn at least in part by fluidly connecting a first right volume of a right hydraulic cylinder to high pressure;
fluidly connecting a second right volume of the right hydraulic cylinder and a first left volume of a left hydraulic cylinder to low pressure; and, supplying a left second volume of the left hydraulic cylinder with a left medium pressure between the high and low pressures; and
performing a right hand high force turn at least in part by fluidly connecting the left first volume to high pressure, fluidly connecting the left second volume and right first volume to low pressure, and supplying the right second volume with a right medium pressure between the high and low pressures.

11. The method of claim 10 including a step of regulating the left medium pressure according to a pressure ratio of the right first volume to the left second volume; and
regulating the right medium pressure according to a pressure ratio of the left first volume to the right second volume.

12. The method of claim 11 wherein the step of regulating the left medium pressure is accomplished by adjusting a position of a valve member of a right high force steering valve; and
the step of regulating the right medium pressure is accomplished by adjusting a position of a valve member of a left high force steering valve.

13. The method of claim 12 including a step of biasing the valve member of the right high force steering valve toward a position at which the left second volume is fluidly connected to low pressure but fluidly closed too high pressure; and
biasing the valve member of the left high force steering valve toward a position at which the right second volume is fluidly connected to low pressure but fluidly closed to high pressure.

14. The method of claim 13 wherein the step of adjusting a position of the valve member of the right high force steering valve is accomplished with hydraulic force; and
the step of adjusting a position of the valve member of the left high force steering valve is accomplished with hydraulic force.

15. The method of claim 14 including a step of performing a left hand low force turn at least in part fluidly disconnecting a left hydraulic actuator of the left high force steering valve from high pressure; and
performing a right hand low force turn at least in part by fluidly disconnecting a right hydraulic actuator of the right high force steering valve from high pressure.

16. The method of claim 13 wherein the step of adjusting a position of the valve member of the right high force steering valve is accomplished by adjusting a control signal to a right electrical actuator; and
the step of adjusting a position of the valve member of the left high force steering valve is accomplished by adjusting a control signal to a left electrical actuator.

17. A cartridge valve comprising:
a valve body with a high pressure port, a low pressure port, a first cylinder port and a second cylinder port; and
a valve member at least partially positioned in the valve body and being movable among a continuum of positions corresponding to different flow areas from the high pressure port to the second cylinder port.

18. The cartridge valve of claim 17 including an actuator operably coupled to the valve member.

19. The cartridge valve of claim 18 including a dual force relief valve fluidly positioned between the first cylinder port and the hydraulic actuator.

20. The cartridge valve of claim 19 including a hydraulic actuator operably coupled to the valve member.
